(19) United States
(12) Patent Application Publication
(10) Pub. No.: US 2011/0258543 A1
(43) Pub. Date: Oct. 20, 2011

(54) DIALOG SYSTEM

(75) Inventors: Staffan Larsson, Goteborg (SE); Fredrik Kronlid, Svanesund (SE)

(73) Assignee: TALKAMATIC AB, Goteborg (SE)

(21) Appl. No.: 13/126,814

(22) PCT Filed: Oct. 30, 2009
(86) PCT No.: PCT/EP2009/064347

§ 371 Date: Jun. 10, 2011

(30) Foreign Application Priority Data
Oct. 30, 2008 (SE) 0802306-1

(51) Int. Cl. G06F 3/16; G06F 3/048; G06F 3/041

(52) U.S. Cl. 715/702

(57) ABSTRACT

The present solution relates to a method for handling a menu-based user interface, input is received through the user interface. The input is at least one of audio input and menu navigation device input. The input is processed using Basic Dialogue, “BD” and Speech Cursor, “SC”, and then output is provided through the user interface. The output is at least one of audio output, and audio and visual output.

### TECHNICAL FIELD

This invention relates to a method, device and system for handling a menu-based user interface, and a car comprising the system.

### BACKGROUND

A major problem with available voice control technologies is that they are not flexible enough in terms of the interaction strategies and modalities offered to the user. Voice interaction has at least two potential advantages. First, voice interaction is a very natural means of communication for humans, and enabling spoken interaction with technologies may thus make it easier and less cognitively demanding for people to interact with machines. However, this requires that the spoken interaction is similar to ordinary spoken human-human dialogue.

A second argument for using spoken interaction in for example a car context is that the driver should be able to use a system without looking at a screen. However, there are many situations where current technology requires the user to look at a screen at some point in the interaction.

Imagine that the user wants to select a song from a song database, and that the user has made restrictions filtering out 30 songs from the database. The dialogue system asks the user which of the songs she wants to hear displaying them in a list on the screen.

The user must now either look at the screen and use a scrollwheel or similar to select a song, or look at the screen to see which songs are available, and then speak the proper song title. This means that part of the point of using spoken interaction in the car is lost. The example discusses car use, but is applicable any time when the user cannot or does not want to look at a screen, for instance when using a cellphone walking in a city, or when using a web application on a portable device.

One existing solution to the problem is to introduce a first kind of metadialogue over the Graphical User Interface (GUI). This solution addresses the problem of having to look at the screen, but limits the spoken interaction to navigation control (“next”, “select” etc.). This lack of domain-directed dialogue functionality makes for a quite unnatural style of interaction, very different from ordinary spoken dialogue. Thus, the first advantage of spoken interaction mentioned above is lost. Also, if there is an interruption in the interaction (when the driver is under occasional high cognitive load caused by the traffic situation etc.), the user must remember which screen was active before the pause (which adds cognitive load), or look at the screen (which is what we were trying to avoid).

Another existing interaction strategy is a kind of “metadialogue”, where the system verbally presents a number of items (for instance 5) from a list, then asking the user if she or he would like to hear the subsequent 5 items, until the list has been read in its entirety or until the users responds negatively. This kind of readout means that
The user cannot easily navigate the list
The user cannot use knowledge about the position of a certain item in a list
The overview of the list is lost

Some voice interaction systems use a technology to establish understanding which consists of displaying the top N best recognition hypotheses to the user, each one associated with a number, together with a verbal request to the user to say the number corresponding to the desired result. This situation also requires the user to look at a screen, and is quite unnatural. It would be easier on the user if she is allowed to interact in a way which is more similar to human-human dialogue.

### SUMMARY

It is thus an object of the present invention to provide an improved handling of a menu-based user interface.

According to a first aspect of the present solution, the objective is achieved by a method for handling a menu-based user interface. Input is received through the user interface. The input is at least one of audio input and menu navigation device input. Then, the input is processed using Basic Dialogue, “BD” and Speech Cursor, “SC”. Output is provided through the user interface. The output is at least one of audio output, and audio and visual output.

According to a second aspect of the present solution, the object is achieved by a device for handling a menu-based user interface. The device comprises a receiver interface arranged to receive input through the user interface. The input is at least one of audio input and menu navigation device input. The device further comprises a processor arranged to process the input using Basic Dialogue, “BD” and Speech Cursor, “SC”, and a communication interface arranged to provide output through the user interface. The output is at least one of audio output, and audio and visual output.

According to a third aspect of the present solution, the object is achieved by a system for handling a menu-based user interface. The system comprises a receiver interface unit arranged to receive input through the user interface. The input being at least one of audio input and menu navigation device input. The system further comprises a processing unit arranged to process the input using Basic Dialogue, “BD” and Speech Cursor, “SC” and a communication interface unit arranged to provide output through the user interface. The output is at least one of audio output, and audio and visual output.

Thanks to Basic Dialogue, “BD” and Speech Cursor, “SC”, improved handling of a menu-based user interface can be achieved.

The present technology affords many advantages, for which a non-exhaustive list of examples follows:

An advantage of the present solution is that it offers a great variety of interaction styles which can be used in different settings and which can be freely chosen and combined by the user. The user of the system does not need to follow the system's initiative and flexible dialogue interaction is available. Another advantage is that the user may freely choose between using domain-level spoken utterances (requests, confirmations, questions, answers etc.).

The present invention is not limited to the features and advantages mentioned above. A person skilled in the art will recognize additional features and advantages upon reading the following detailed description.

It is easy for the user if she is allowed to interact in a way which is more similar to human-human dialogue. For example, the user should be allowed to issue spoken requests directly to the system (e.g. “Call Jim”) and receive a spoken confirmation that this is being done. However, the interaction in the present solution in not limited to speech only; the user may have different needs depending on the situation, and should ideally be able to freely choose the mode of interaction. Furthermore, it would be useful to add more complex interaction strategies to make the spoken interaction more natural and thus less cognitively demanding and more easy to use.

### BRIEF DESCRIPTION OF THE DRAWINGS

The invention will now be further described in more detail in the following detailed description by reference to the appended drawings illustrating embodiments of the invention and in which:

FIG. 1 is a schematic block diagram illustrating an embodiment of the present solution.

FIG. 2 is a flow diagram illustrating basic dialogue interaction

FIG. 3 is a flow diagram illustrating an embodiment of grounding.

FIG. 4 is a flow diagram illustrating an embodiment of grounding.

FIG. 5 is a flow diagram illustrating multiple topics.

FIG. 6 is a flow diagram illustrating an embodiment of accommodation.

FIG. 7 is a flow diagram illustrating an embodiment of accommodation.

FIG. 8 is a flowchart depicting embodiments of a method.

FIG. 9 is a block diagram illustrating embodiments of a device.

FIG. 10 is a block diagram illustrating embodiments of a system.

### DETAILED DESCRIPTION

The present solution relates to a dialogue system for conveying information about, and the possibility to manipulate and navigate in, the contents of a list, a menu or similar structure, without the need for the user to look at a screen. Additionally, the solution provides the possibility to search a database incrementally using a dialogue system and to handle interruption of a dialogue.

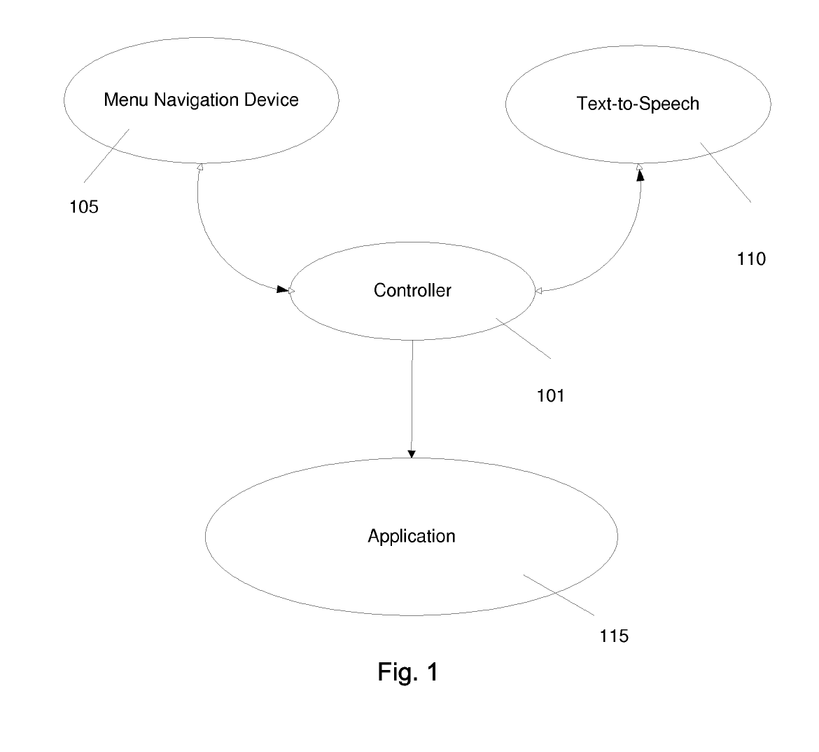

FIG. 1 shows a schematic block diagram illustrating an embodiment of the present solution. A controller 101 receives input from a menu navigation device 105 and sends output to a Text-To-Speech (TTS) 110. The controller 101 collects information about a widget (which is to be managed) from an application 115 and provides the application 115 with information about the items in focus/selected elements.

### Speech Cursor

A menu system may have a tool for navigating, arranged to be used by a user, in the menu system, including marking alternatives in a list. On an ordinary computer, this may be done using a cursor or pointer which is controlled by a pointing device, including (at least) one button on the pointing device which is used to mark alternatives. The minimal requirements for choosing a single alternative in a list may be:
P: A pointer or cursor indicating which item the user of the navigation tool is pointing at. This can either be as a result of the cursor being over the list item, or by different colouring. The pointer can only point at one item at the time.
DOWN: A way to navigate downwards in the list, to move the cursor/pointer further down in the list. This can e.g. be done by moving a pointing device to the next item, pushing a “down”-button, or rolling a scroll-wheel.
UP: A way to navigate upwards in the list, to move the cursor to the previous alternative. E.g. by moving a pointing device upwards, “up”-button, scroll-wheel.
KK: Select an item

The minimal requirements for choosing several (discontinuous) alternatives in a list may be:
M: An indication of what alternative or alternatives is/are marked, e.g. by different colouring.
K: A way of marking a certain alternative or item, e.g. by clicking on it.
OK: A way of indicating that all desired items have been marked, e.g. by clicking an “OK” button.
KK: There might also be a possibility to simultaneously mark an item and indicate that this is the only desired item, for instance by double-clicking. This is equivalent to selecting an item in the single-alternative solution

We will in the following name such a device a menu navigation device. Examples of menu navigation devices may be:
mouse (e.g. trackball, touch pad, TrackPoint™) with buttons, pointers and drivers.
keyboard with arrow keys
jog dial/shuttle wheel

The concept Speech Cursor (SC) comprises a user interface for navigating in and manipulation of building blocks in a menu-based interface (alternatives in menus, buttons, textboxes, check-boxes, lists). Input (e.g. DOWN, UP, KK and possibly K and OK) to the user interface is collected from a menu navigation device. The output consists of spoken language in the form of verbal representations of the elements in the building block.

In a second embodiment a user interface like in the first embodiment described above, is provided, but where input (DOWN, UP, KK and possibly K and OK) can be collected from a menu navigation device or from the user utterances.

In a third embodiment, also a user interface like in the first embodiment is provided, but where input (DOWN, UP, KK and possibly K and OK) is collected from user utterances only.

Thus, the input to the user interface can be a menu navigation device, a menu navigation device or user utterance, or only user utterance.

By introducing a voice cursor the user is given the general opportunity to navigate menu systems without the need to look at a screen.

Every time a new item gets focus when the user navigates in the menu, the system is reading out a “voice icon”, a spoken representation of the alternative. This representation can be textual, intended to be realized using a Text-to-Speech (TTS) function, or in the form of audio data, to be played directly. Every time a new element is in focus, all possible voice output is aborted, and the “voice icon” for the element in focus is spoken.

### Basic Dialogue Interaction

Basic dialogue interaction (BD) comprises mechanisms handling interaction where a user and the system take turns to produce utterances or sequences of 2 or more utterances (stretches of uninterrupted speech), where one or both of system and user can produce at least one or several of the following utterance types: requesting information, providing information, requesting actions, and confirming the status of requested actions.

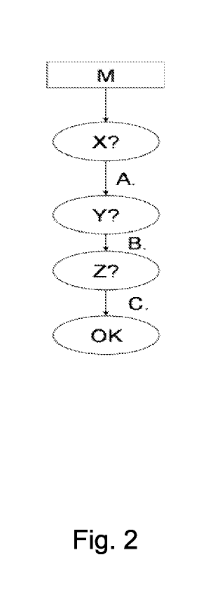

FIG. 2 shows a schematic overview of an example basic dialogue interaction flow, beginning with the user requesting a menu action M, which first triggers the system to ask a question “X?”. The user responds to “X?” by uttering the answer “A.”, after which the system proceeds to ask the question “Y?”, receiving the answer “B.”, and similarly for “Z?” and “C.”. Finally, the system confirms that the requested action M has been completed.

In a mobile phone setting, the schema in FIG. 1 could correspond to the following interaction (S designates the system, U designates the user):
U: Add a new number to the phonebook. (M)
S: What is the name of the person you want to add? (X?)
U: Jim. (A.)
S: What kind of number is it—mobile, home or work? (Y?)
U: A mobile phone number. (B.)
S: What is the number? (Z?)
U: 0713 45 56 67 (C.)
S: OK, the number has been added. (OK)

Note that basic dialogue input normally takes the form of domain-level utterances rather than utterances referring to menu navigation actions (DOWN, UP, KK and possibly K and OK), although the latter is also an option. For example, when asking about the name of the person (X?) above the system may display a list of names such as [Bob, Jane, Jim, John] on the screen; if the system provides speech cursor interaction the user might respond by saying “Down. Down. Down. Select.” (corresponding to DOWN-DOWN-DOWN-KK) and thereby selecting “Jim” from the list. In such a system, both this option and the option of simply saying “Jim” are available.

There are several existing system designs for managing basic dialogue interaction. The present solution for basic dialogue interaction is based on the concept of a dialogue information state containing information about the state of the dialogue, and update rules and update algorithms which update the dialogue information state based on observed and produced dialogue moves (abstract semantic descriptions of utterances). More specifically, the information state may comprise the following information:
GOALS: a stack of goals (including information-seeking goals, i.e. questions) which has been requested but not yet completed. A stack structure allows operations of pushing elements to be topmost on the stack, and popping the stack thus removing the topmost element. Optionally, GOALS may be an “open stack” which works as a stack but also allows access to non-topmost elements.
FACTS: a set of agreed-upon “facts” which the user and the system have agreed upon.
PLAN: a plan for how to proceed with the dialogue in the absence of user initiative.
LU: a representation of the dialogue moves performed in the latest utterance.
NIM: a list of dialogue moves whose effects have not yet been integrated into the information state.
LATEST-MOVES: a list of dialogue moves performed in the latest utterance (by the user or the system). For user utterances, such moves may constitute an interpretation of spoken audio user input, as offered by a module or set of modules (e.g. speech recognition and natural language interpretation). Moves may also constitute interpretations of user manipulations of a menu navigation device.
NEXT-MOVES: a list of dialogue moves to be performed by the system. Such moves may be rendered as spoken audio output by a module or set of modules (e.g. natural language generation and speech synthesis). Moves may also be rendered as graphical output.

In addition, the dialogue system may be connected to a database or device which is able to carry out information searches and/or other actions, e.g. such as calling a person. The system may also have a store of domain knowledge, comprising dialogue plans designed for dealing with requests from the user, as well as specifications of which answers count as relevant and resolving for questions, and of what is required for an action to be considered as completed.

Basic dialogue interaction is dealt with by update rules and algorithms according to the following principles:
If the user or system requests an action (including asking questions), the corresponding goal is pushed on the GOALS stack,
If goal G is topmost on the goal stack, and there is currently nothing in the plan slot, and there is a plan P for dealing with G in the domain knowledge resource, then enter P into the plan slot,
If A is the first item in the plan slot, the following is done depending on what A is
   If A=findout(Q), then ask the question Q; do not remove A until Q has been resolved (for obligatory questions).
   If A=raise(Q), then ask Q; remove it once Q is on the goal stack (for voluntary questions).
   If A=consult-database-or-device (Q), then consult the current database or device to find the answer to Q, given the currently established facts; if a relevant answer A is found, enter an answer-move with content A into NEXT-MOVES.
   If A=device-do(ACTION) where ACTION is an action to be carried out by a device connected to the dialogue system, then send a request to the device to carry out ACTION, and enter a confirmation move into NEXT-MOVES.
If the user makes an answer-move with content ANSWER, then if ANSWER is relevant to the topmost information-seeking goal Q on GOALS, add to FACTS the proposition resulting from combining Q and ANSWER. For example, if the user says “Jim” and topmost on GOALS is a question concerning who to call, enter the fact that Jim is the person to call to FACTS.
If the PLAN is empty and there are no moves in NIM, do nothing. Alternatively, return to the toplevel menu and ask what the user wants to do next.
Moves are moved from LATEST-MOVES to NIM before being processed. A single utterance may be analysed as comprising several moves. NIM may contain moves from utterances earlier in the dialogue, which have not yet been processed.

See also Larsson 2002, Chapter 2. There are several system designs for managing basic dialogue interaction, and the one presented above is included as an example. Other designs include state-based dialogue modeling and earlier versions of Voice Extensible Markup Language (VXML).

### Flexible Dialogue

Flexible Dialogue (FD) comprises an addition to basic dialogue interaction (BD), comprising one or more of the following mechanisms: grounding, accommodation, multiple topics, and meta-dialogue.

### Grounding

Grounding refers to a method of verifying the validity of the system's interpretation of user input. Grounding can be performed in several different ways, such as e.g. the following:

(a) Basic grounding: Providing feedback to the user indicating the system's perception and interpretation of user input, and giving the user an opportunity to confirm or reject the system's perception or interpretation. For example, if the user says “Call a person”, the system may give feedback “Do you want to call a person?”, “Call a person, is that correct?”, “OK, call a person” or similar. The user may reply “yes” or “no” in response to this feedback (or may not say anything), and the system should react appropriately. If the user says “no”, the system should assume that its hypothesis about what was said or meant was mistaken. In some cases, a lack of response from the user in reaction to system feedback may also indicate a mistake by the system.

(b) Multimodal grounding: This is as in (a) but where system feedback is provided both using spoken and graphical output (e.g. on a display), and where the user's response to system feedback (indicating either that the system's hypothesis is correct or incorrect) is provided either using speech or using a menu navigation device. For example, in response to “Call a person”, the system may ask (and display) “Do you want to call a person”, and a menu with the choices “yes” and “no” may be displayed. The user may then answer verbally (as in (a)), or select one of the choices using the menu navigation device.

(c) Multi-choice grounding: This is as in (a) but with the system's feedback comprising, in addition to or instead of the available options indicating correctness or incorrectness, a list of other options corresponding to additional hypotheses by the system as to what the user said or meant. As an example of (c), when the system gives spoken feedback of the type (S: System, U: User):
S: I heard you saying “Main Street”. Is that correct?

The user can then answer by using his or her voice, saying “Yes” or “No” or repeat the utterance. If the user answers “no”, The system may proceed to offer another hypothesis as to what the user said or meant:
U: No
S: OK. Did you say “Sweet Dreams?”

Alternatively, the system may offer several alternatives in a single utterance, e.g.
S: Did you say “Main Street” or “Sweet Dreams”? The user can then answer with the correct alternative.

(d) Multi-choice multimodal grounding: This is a combination of (b) and (c) where system feedback is provided both using either spoken, or spoken and graphical output, and where the user's response to system is provided either using speech or using a menu navigation device. The systems feedback comprises, in addition to or instead of the available options indicating correctness or incorrectness, a list of other options corresponding to additional hypotheses by the system as to what the user said or meant. As an example of (d), when the system gives spoken feedback of the type:
S: I heard you saying “Main Street”. Is that correct?
   it can simultaneously give feedback on a screen by showing the following information:

### Yes

### No

### Hypothesis 2

### Hypothesis 3

. . .

### Hypothesis N

The user can then answer by using his or her voice, saying “Yes” or “No” or repeat the utterance or anything else that the dialogue system can interpret in the current state. If the user prefers, he or she can use a menu navigation device. When an item is in focus, the system reads out its textual representation, and when the user selects an item, this is used as an answer to the dialogue system.

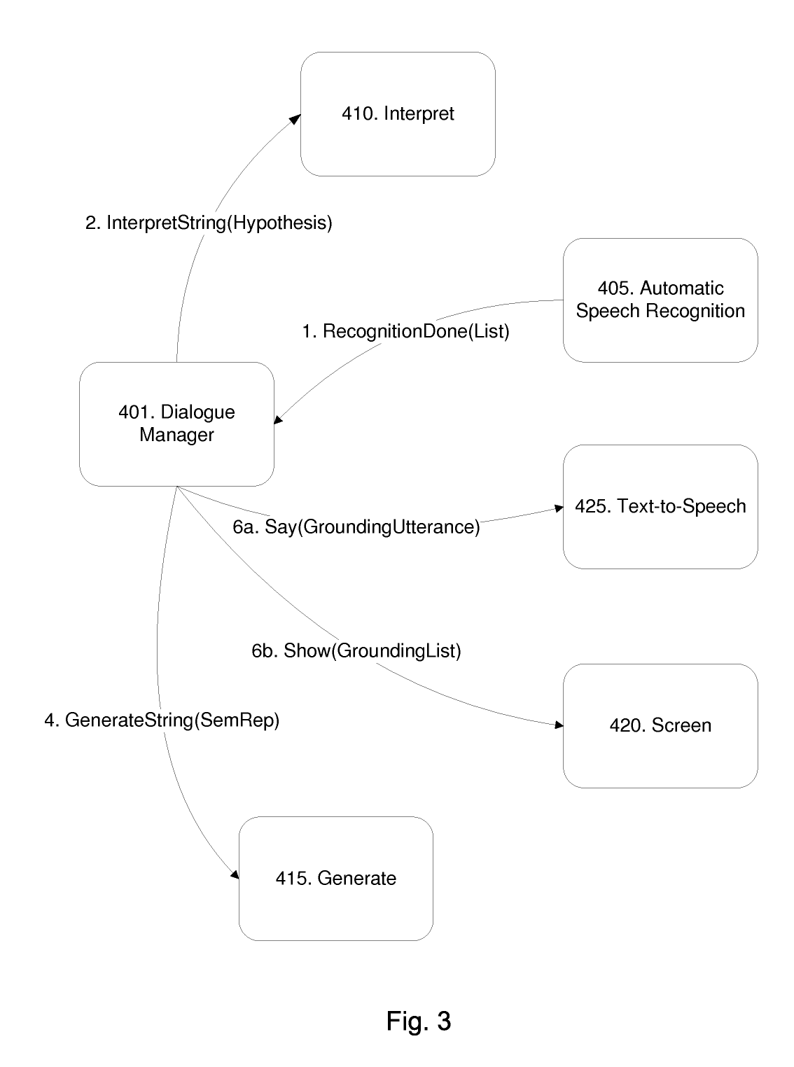

In all of (a)-(d) above, the hypotheses in the list need not be exact string output from an Automatic Speech Recognition (ASR) function, but may be processed in the following manner, as illustrated in FIG. 3:

1. The ASR 405 may produce an ordered list with the N best hypotheses in string format (“N-best-list”), RecognitionDone(List), and transferred to the dialogue manager.

2. The hypotheses are interpreted by an interpretation module 410. The result is a list of semantic representations, InterpretString(Hypothesis).

3. (not shown) Potentially, the list of semantic representations is re-ranked using contextual information.

4. The semantic representations are used as input to a generation module 415, which generate utterances corresponding to the items, GenerateSring(SemRep).

5. (not shown) Doubles may be filtered out.

6a and b. The list of generated utterances may be shown to the user via the screen 420 or as speech via the Text-to-Speech unit 425, Show(GroundingList) and Say(GroundingUtterance).

In this way, the user is shown a list of hypotheses in canonical form. Canonical form is a normalized form of an utterance. Purely as an example, a user may say “Play eh some Madonna. Like a Prayer.” or “Madonna, I would like to hear Like a Prayer.” The system then recognizes these utterances as a request that the system should play the song “Like a Prayer” with the artist Madonna. In that case the system may have a standardized way to generate such a request, for example “Play ‘Like a Prayer’ with Madonna.” This could form the canonical form for the exemplified utterances, and all other utterances having the same meaning.

The system feedback may also concern the semantic sort of the user utterance, rather than what was said. For example, if the user says “Play”, the system may issue a clarification about what was meant focusing on what kind of thing is referred to: “Do you want me to start the player, or do you mean the album “Play” by Madonna?”.

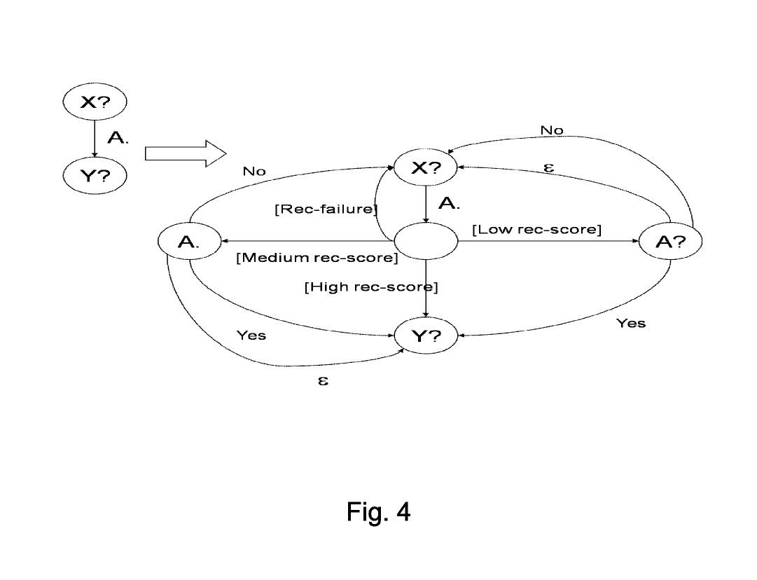

Grounding can be implemented in many ways. If one thinks of dialogue in terms of dialogue state charts, one aspect of the grounding mechanism referred to here can be explained as follows and as illustrated in FIG. 4. Assume that a dialogue state chart describes a basic dialogue interaction of a question being followed by an answer using a transition from a system question “X?”, via an answer “A.” to the next system question “Y?”. In this case, a grounding mechanism may extend the range of possible system reactions to the user's answer “A.”. For example, if a low speech recognition score is assigned to “A.”, the system may react with a confirmation question “A?”. If the user answers “No”, or does not react (epsilon transition), the system repeats the question “X?”. If the user answers “Yes”, the system proceeds to the next question.

If, on the other hand, a medium score is assigned to “A.”, the system may produce a declarative confirmation “A.”. In this case, if the user answers “No”, the system repeats “X?”, but if the user is quiet or answers “Yes”, the system proceeds to the next question “B?”. Finally, if a high score is assigned to “A.”, the system may proceed immediately to the next question.

Grounding mechanisms may take into account not only recognition score but also any aspect of the dialogue information state. Grounding may in addition concern not only what was said, but also what was meant by what was said, and whether what was meant was also acceptable.

Grounding mechanisms may also be described in terms of the dialogue information state and associated update rules and algorithms explained under “Basic dialogue interaction” above. The principles guiding grounding in this setup may be described as follows:
Assume that the user produces an utterance U which is assigned recognition score S by the ASR component of the dialogue system.
if the ASR does not produce an output string, produce feedback indicating lack of perception.
if the ASR produces an output string, then
   if the string can be assigned no semantic interpretation, produce feedback indicating lack of understanding.
   if the string can be assigned a semantic interpretation, put U in the list NIM of non-integrated moves.
for each move in NIM,
   if the semantic interpretation specifies an a full dialogue move M which needs no additional context to be understood, then add the move to LU.
   if the semantic interpretation needs additional context, try to combine the semantic interpretation with an information request (question) on GOALS to achieve a full dialogue move M.
   If this succeeds, then
      if S is at least medium high, and of the content of M is acceptable, integrate the content of M into the dialogue information state (add statements to FACTS, questions and requests to GOALS, etc.); optionally produce feedback indicating acceptance (“OK.”).
      if S is medium high, select a declarative grounding move for NEXT-MOVES (“A.”).
      if S is low, select an interrogative grounding move for NEXT-MOVES (“A?”)
   if no full move can be achieved, optionally produce feedback indicating what was perceived (“I head you say A.”). Then ask a clarification question regarding the intended content of the move (e.g. “What do you mean?”), possibly mentioning some possible hypotheses (“Did you mean A, B, or C”?)
   If the content of M is not acceptable, produce feedback indicating rejection (e.g. “Sorry, I cannot answer that question”).
   When integrating a grounding-related utterance from the system, enter it as an information-seeking goal on the GOALS stack. User responses to feedback from the system will be interpreted in light of the content of the GOALS stack, and the dialogue information state is justified accordingly. If a negative response from the user is received in response to an declarative grounding move (“A.”), the corresponding content should be retracted and the system should repeat the latest question (“X?” in the example above).

For a detailed exposition of these mechanisms, see Larsson 2002, Chapter 3.

### Multiple Topics

“Multiple topics” refers to a method for handling user inputs associated with menus or topics other than the menu or topic currently being executed or discussed
(a) by changing the menu/topic to the one requested by the user,
(b) as in (a) but in addition returning to the initial menu/topic once the second menu/topic has been finished, thus completing an interaction associated with at the initial menu even if the interaction has been interrupted, possibly taking into account information gathered during the interaction pertaining to the second menu/topic (“information sharing”),
(c) as in (a) but in addition returning to the initial topic whenever this is requested by the user, and possibly later returning to the second topic again,
(d) as in (a) but combining (b) and (c),
(e) as in (a-d) allowing for any fixed number of simultaneously active topics (one of which is the current topic),
(f) as in (a-e), where the system explicitly indicates some or all topic changes using verbal and graphical output, or both.

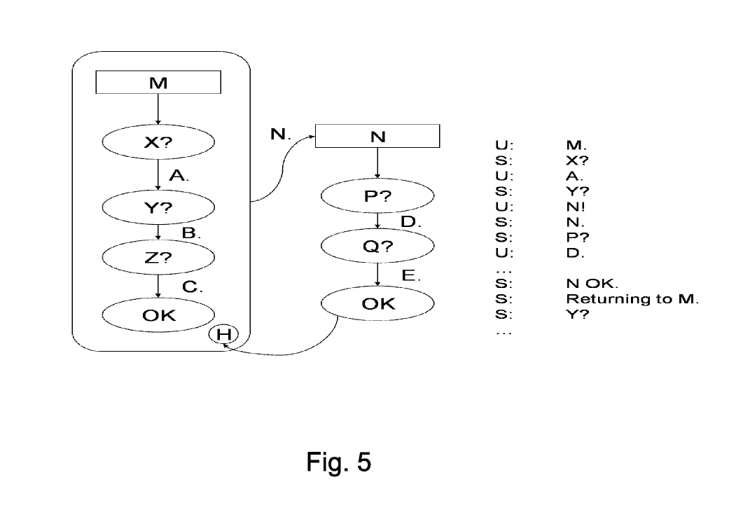

A schematic example of interaction involving switching between multiple topics is show in FIG. 5. The user initially introduces the menu action M, and the system proceeds to ask a number of questions and receiving answers from the user. At any point during this interaction (in the example, after the system has asked “Y?”), the user may introduce a new menu action N, which may then be confirmed by the system. The system then proceeds to deal with N by asking a sequence of actions [P?, Q?] and receiving answers from the user. After completion of N has been confirmed by the system, the system switches back to dealing with M and explicitly indicates this (as described in (d) above). The system then proceeds to deal with M, by repeating the unresolved question “Y?”.

Note that there need be no specific limitation to the number of simultaneously active topics. Note also that the interactions for topics themselves may be more complex than the ones shown in FIG. 5. Note also that information collected during an embedded dialogue (N in the example above) may be used to infer information relevant to the embedding dialogue (M in the example above).

Mechanisms for dealing with multiple topics may also be described in terms of the dialogue information state and associated update rules and algorithms, as above. A set of principles guiding the handling of multiple topics in this setup can be described as follows:
If the user or system requests an action (including asking questions), the corresponding goal G is pushed on the GOALS stack. If the PLAN field is nonempty, clear then PLAN field. If G was already on the GOALS stack, but not topmost, then raise G to be topmost on GOALS.
If goal G is topmost on the goal stack, and there is currently nothing in the plan slot, and there is a plan P for dealing with G in the domain knowledge resource, then enter P into the plan slot. (NOTE: This is already included in BD, and is repeated here for exposition purposes only.)
If a goal G has been completed, pop G from the GOALS stack. Optionally, if there is a further goal H which is topmost on the GOALS stack after G has been popped, then issue a dialogue move from the system to indicate that the interaction is now returning to the topic H (e.g. “Returning to H”).

Together with the principles of Basic Dialogue, this will yield the desired behavior. Note that multiple goals may also be introduced by the system (not only by the user).

For a detailed exposition of these mechanisms, see Larsson 2002, Chapter 2 and 3.

### Accommodation

“Accommodation” refers to a method for handling inputs from the user comprising information in addition to, or different from, the information requested by the system, more precisely one of the following cases:

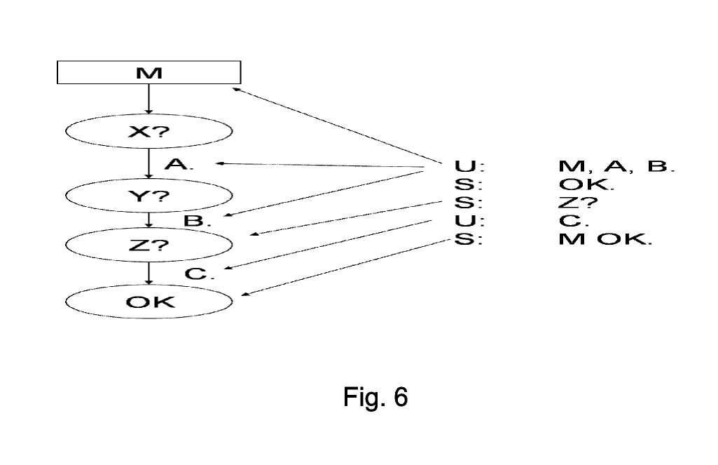

(a) Information pertaining to the current menu, but which has not yet been requested; this results in the information being integrated and not later requested by the system. A schematic example is shown in FIG. 6, where the user provides unrequested information A and B when requesting the menu action M. In a mobile phone setting, an example of such an utterance would be “Add Jim's new mobile number to the phonebook” which requests an action to add a number to the phonebook (M) and provides the name (A) and the number type (B).

(b) Information pertaining to the current menu, but which has already been received; this results in overwriting the previous information with the newer information

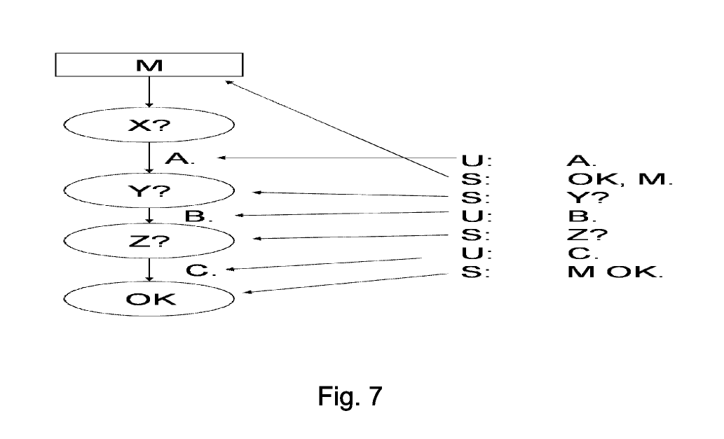

(c) Information pertaining to a menu other than the currently active one; this may result in entering the menu to which the information pertains (“intention recognition”), or (if there are several menus to which the information pertains) requesting the user to specify which menu to enter (“intention clarification”). A schematic example is shown in FIG. 7, where the user does not explicitly request a menu action M but instead supplies the information A relevant to M; the system then infers that the user wants to do M and proceeds to deal with M, avoiding to ask the already resolved question “X?”. In a mobile phone setting, A might be “Jim.”, triggering the system to assume that the user wants to add a number to the phonebook, proceeding to the question of number type (Y?). In an alternative solution, intention recognition is only carried out before any menu (other than the top-level menu) has been selected.

(d) As in (a)-(c), where the system explicitly indicates some or all cases of handling inputs from the user comprising information in addition to, or different from, the information requested by the system, using verbal or graphical output, or both. As an example, the system's utterance “OK, M” in FIG. 7 indicates that the system is assuming that the user wants to do M, based on the unrequested input “A.”.

Mechanisms for dealing with accommodation may also be described in terms of the dialogue information state and associated update rules and algorithms, as above. A set of principles guiding the handling of accommodation in this setup can be described as follows:
If the user performs a move (e.g. an answer) with content A which provides information not relevant to any information-seeking goal (question) on GOALS, then:
   Try Direct Accommodation: If a question Q matching A is found in a plan item in the PLAN field (e.g. findout(Q)), then push Q on the GOALS stack. Then, try integrating the move with content A again; it will now match a question on the GOALS stack. (A question matches an answer if and only of the answer is relevant to the question).
   Otherwise, try Revision: If a single question Q matching A is found in a plan item of a plan P associated with a goal G in the domain knowledge resource, and G is on the GOALS stack, and there is a proposition P in FACTS which also resolves Q, then delete P from FACTS, and push Q on GOALS. Then try integrating the move with content A again. (If G was not topmost on the GOALS stack, it should be raised to the top and the corresponding plan should be loaded).
   Otherwise, try Dependent accommodation: If a single question Q matching A is found in a plan item of a plan P associated with a goal G in the domain knowledge resource, push G on GOALS and load P into the PLAN field; then try Direct Accommodation again.
   Otherwise, try Dependent Clarification: If several questions Q1, Q2, . . . Qn matching A are found in plan items of plans P1, P2, . . . Pn associated with goals G1, G2, . . . Gn in the domain knowledge resource, ask the user which of the goals G1, G2, . . . Gn to pursue; when the user answers, push the selected goal on GOALS and load the corresponding plan to the PLAN field. Then try Direct Accommodation again.
   Alternatively, allow Dependent Accommodation and/or Dependent Clarification only if the PLAN field is empty.
   Alternatively, Revision may be tried after Dependent Accommodation or after Dependent Clarification.

For a detailed exposition of these mechanisms, see Larsson 2002, Chapter 4. There are several system designs for managing flexible dialogue interaction, and the one presented above is included as an example. Other designs include state-based dialogue modelling and for some aspects of flexible dialogue later versions of VXML.

### Metadialogue

Metadialogue comprises providing menu navigation location information upon request from the user, indicating one or more of the following: current topic under discussion; list of currently open topics; agreed-upon facts or propositions; moves carried out so far; device actions carried out so far, etc. For example, if the user says “Where were we?” after a pause in the interaction caused by external events, the system may respond “We were adding a name to the phonebook; you had just specified the name to add as Jim.”. Technically, this is solved by implementing special processing rules for such dialogue moves, which inspect the dialogue information state to e.g. find answers to meta-level questions.

### Multimodal Parallelism

Multimodal Parallelism (MP) comprises a correspondence between spoken utterances and menu manipulations according to the following:
A multiple choice menu corresponds to an alternative-question, i.e. a question offering a number of choices corresponding to the menu items.
If a multiple choice menu is displayed, each item corresponding to a dialogue action (including requesting an action, requesting information, confirming an action, or providing information), selecting an item has the same effect as a spoken dialogue action (except that manually selecting an item does not require the system to confirm the what the user said or meant).
A list corresponds to a wh-question (what, where, who, when, etc.), i.e. a question asking for one or several items of some kind (e.g. a song), with items or sets of items in the list being a possible answer to the wh-question. Items may correspond to dialogue actions (e.g. answers, requests, questions).
If a list of choices is displayed, each item corresponding to a dialogue action (e.g. an answer, a request, or a question), selecting one or several items has the same effect as the corresponding dialogue action or sequence of dialogue actions action (except that manually selecting an item does not require the system to confirm the what the user said or meant).
A tick-box corresponds to a yes/no question, i.e. a question which can be resolved by a “yes” or “no” answer.
If a tick-box is displayed, corresponding to a yes/no question, ticking the box corresponds to providing a positive (yes) answer, whereas leaving the box unticked corresponds to providing a negative (no) answer. Alternatively, ticking or unticking the box and then confirming the choice (e.g. by clicking “Okay”) may correspond to providing a “yes” or “no” answer, respectively.
A text entry box corresponds to a wh-question, i.e. a question asking for one or several items of some kind (e.g. a song), offering the user the possibility to answer to the wh-question by entering a sequence of symbols.
If a text entry box is displayed, corresponding to a wh-question, providing the requested information verbally has the same effect as filling in information manually (i.e. using a keyboard or a menu navigation device).
Pop-up messages correspond to confirmations or other dialogue actions which do not require the user to answer any question, but may require the user to confirm that they have received the message.
If a pop-up message is displayed, making an utterance indicating acceptance (e.g. “okay”) has the same effect as confirming reception of the message (e.g. by clicking the “OK” button in the pop-up message window).

For a detailed exposition of these principles, see [1] and [2].

### Combinations

The above concepts may be combined in various ways. The combinations BD+SC, BD+SC+MP, BD+FD+SC, and BD+FD+SC+MP are described as examples. All these combinations solve the problem of being able to do all the interaction without looking at a screen, so that e.g. in a car all interaction can be carried out using only haptic input and spoken output during driving. All combinations also solve the problem of navigating long lists without looking at a screen. All combinations which include FD address the problem of the interaction increasing the cognitive load imposed on the user, by allowing the user to express herself more freely (accommodation and multiple topics), and also by helping the user to keep track of what is going on in the interaction (grounding and metadialogue).

### Basic Dialogue and Speech Cursor

Combining Basic Dialogue processing with the Speech Cursor, BD+SC, (but without Multimodal Parallelism) concept enables interaction where the interaction may be carried out either using domain-level spoken utterances (requests, confirmations, questions, answers etc.) or using the Speech Cursor. This is an improvement over existing technology in that it offers a greater variety of interaction styles which can be used in different settings.

The system designer may decide when it is more appropriate to use SC interaction, e.g. when a large database needs to be browsed. An advantage of this combination is that the speech recognition grammar can be smaller and thus more accurate.

Here is a walk-through of a sample interaction using the BD+SC combination:
The system starts out in domain-level dialogue mode, and says “What do you want to do?”
The user says “I want to add a song to the playlist”.
ASR is reporting to the dialogue manager that the user has done an utterance “I want to add a song to the playlist”.
The dialogue manager enters the dialogue plan for solving the task “add songs to playlist”.
The dialogue manager asks the music database what songs are available.
The dialogue manager switches to Speech Cursor mode and displays the available songs.
The user can use the menu navigation device to browse the songs. The (P) element (the element in focus) is spoken using to the following process: the textual information associated with the list elements sent to the TTS unit (the data is passed either to the dialogue manager, or directly to the TTS unit).
If the user has selected songs using the menu navigation device (K and OK, or KK) the interface reports to the dialogue manager that the user has made a choice.
The dialogue manager sends appropriate information about the songs to the music player.

### Basic Dialogue, Speech Cursor and Multimodal Parallelism

Combining Basic Dialogue processing with the Speech Cursor and Multimodal Parallelism concept, BD+SC+MP, enables interaction where the user may freely choose between using domain-level spoken utterances (requests, confirmations, questions, answers etc.) and using the Speech Cursor. This is an improvement over existing technology in that it offers a greater variety of interaction styles which can be freely chosen and combined by the user. Another advantage of this combination is that the speech recognition grammar can be smaller and thus more accurate.

Here is a walk-through of an example interaction using the BD+SC+MP combination:

1. The user uses voice to request that the system to add a song, e.g. by saying “I want to add a song to the playlist”.

2. ASR is reporting to the dialogue manager that the user has done an utterance “I want to add a song to the playlist”.

3. The dialogue manager enters the form/automaton for solving the task “add songs to playlist”.

4. The dialogue manager asks the music database what songs are available.

5. The dialogue manager follows the form by asking the user which of the available songs the user wants to add.

6. In parallel with the question, the stored list of songs is displayed for the user.

7. The user can use the menu navigation device to browse the songs. The (P) element (the element in focus) is spoken using to the following process: the textual information associated with the list elements sent to the TTS unit (the data is passed either to the dialogue manager, or directly to the TTS unit).

8. If the user has selected songs using the menu navigation device (K and OK, or KK) the interface reports to the dialogue manager that the user has made a choice. The dialogue manager interprets this information as answers to the recently asked question.

9. If the user has selected a number of songs by saying their titles, this is interpreted as answers to the recently asked question.

10. The dialogue manager sends appropriate information about the songs to the music player.

### Basic Dialogue, Speech Cursor and Flexible Dialogue

Combining Basic and Flexible Dialogue processing with the Speech Cursor (but without Multimodal Parallelism) concept, BD+SC+FD, enables interaction where the interaction may be carried out either using flexible spoken domain-level dialogue (encompassing requests, confirmations, questions, answers etc.) or using the Speech Cursor. This is an improvement over existing technology in that it offers a greater variety of interaction styles which can be used in different settings.

An advantage of the combination is that the system designer may decide when it is more appropriate to use SC interaction, e.g. when a large database needs to be browsed. Another advantage of this combination is that (in domain-level dialogue mode) the user does not need to follow the system's initiative and that flexible dialogue interaction is available.

Here is a sample interaction using the BD+SC+MP combination:
U: I want to listen to Madonna
   Comment: this utterance uses accommodation to allow the user to supply unrequested information
S: OK, Madonna. There are 3 songs by Madonna. Please select a song.
   Comment: These utterances uses grounding to confirm that the system got “Madonna” right. The system now switches to SC mode.
U: [DOWN]
S: “Like a Prayer” from the album “Like a Prayer”
U: [DOWN]
S: “La Isla Bonita” from the album “True Blue”
U: [DOWN]
S: “Music” from the alb . . .
U: [UP]
S: “Like a Prayer” . . .
U: [KK]
S: OK, playing “Like a Prayer”.
   Comment: the system now returns to domain-level dialogue mode.

### Basic Dialogue, Speech Cursor, Flexible Dialogue, Multimodal Parallelism

Combining Basic and Flexible Dialogue processing with the Speech Cursor and Multimodal Parallelism concept, BD+FD+SC+MP, enables interaction where the user may freely choose between using domain-level spoken utterances (requests, confirmations, questions, answers etc.) and using the Speech Cursor. This is an improvement over existing technology in that it offers a greater variety of interaction styles which can be freely chosen and combined by the user, as well as offering flexible dialogue interaction. Another advantage of this combination is that (in domain-level dialogue mode) the user does not need to follow the system's initiative and that flexible dialogue interaction is available.

Here is a walk-through of a sample interaction using the BD+FD+SC+MP combination:
U: I want to listen to Madonna
   Comment: this utterance uses accommodation to allow the user to supply unrequested information
S: There are 3 songs by Madonna. What song do you want? [Showing list of all songs by Madonna]
U: [DOWN]
S: “Like a Prayer” from the album “Like a Prayer” [“Like a Prayer” is marked in a contrasting color]
U: [DOWN]
S: “La Isla Bonita” from the album “True Blue” [“La Isla Bonita” is marked in a contrasting color]
U: [DOWN]
S: “Music” from the alb . . . [“Music” is marked in a contrasting color]
U: [UP]
S: “Like a Prayer”.
U: [KK]
S: OK, playing “Like a Prayer”.

Here is a further example:
U: “I want to add an ABBA song”
S: “what album?” (shows “Waterloo” and “Arrival)
U: [DOWN]
S: Wat . . .
U: [DOWN]
S: Arrival
U: [M] [OK]
S: “what song?” (shows “Mamma Mia” and “Money Money Money”).
U: “Mamma Mia”.

### Incremental Search

Incremental search is a desirable feature of a dialogue system. The feature lets the user gradually specify a query. This can be useful for instance when selecting songs for a playlist. Step by step the user specifies the artist, the album and, finally, songs.

The absence of the feature becomes especially clear in multi-modal dialogue, when the dialogue is combined with a GUI, because the feature is very common, and easy to implement, in GUIs.

To achieve incrementality and to get access to the state of the GUI, it is required that the following items are stored:
The search restrictions stated so far: RESTR: Set(Prop), a set of propositions, each specifying a search restruction such as artist or album
The possible answers to the current question under discussion Q, with respect to RESTR: CTXT Q: Set(Ind)
The item in focus in the GUI (P): POINTED-AT: Ind
The set of marked alternatives in the GUI: MARKED: Set(Ind)
The sorting principle of the items shown in the GUI: SORTING: Predicate
Sort order for the items shown in the GUI: SORT-INCREASING: Bool

Every time that the user answers a question from the system which is a restriction on the number of possible answers to the underlying issue, this proposition is added to RESTR. If the dialogue manager works according to IBDM [4], shared commitments include RESTR. CTXT. Q are the possible answers to the question Q with respect to RESTR. Every time RESTR is expanded by adding a constraint, CTXT. Q is revised by removing those elements which do not fulfill the restriction set.

When POINTED-AT is updated, data is sent to TTS to be spoken. When the user selects “ok”, the elements in MARKED are sent as a sequence of answer moves to the information state. The GUI shows CTXT for the QUD-maximal Q.

### Example of Interaction:

U: “I want to add an ABBA song”
   (The database contains the ABBA songs “Michelangelo”, “Money Money Money” and “Mamma Mia”)
   RESTR={artist(ABBA)}
   CTXT.id={{id(f45), title(“Michelangelo”), album(“Waterloo”), artist(ABBA)}, {id(a4775), title(“Mamma Mia”), album(“Arrival”), artist(ABBA)} {id(a4776), title(“Money Money Money”), album(“Arrival”), artist(ABBA)}}
S: “what album?” (shows “Waterloo” and “Arrival”) push ISSUES ?x.album(x)
   CTXT.album={{album(“Waterloo”)}, {album(“Arrival”)}}
U: [DOWN]
   POINTED-AT=album(“Waterloo”) [DOWN]
   POINTED-AT=album(“Arrival”) [M]
   add(MARKED, album(“Arrival”)) [OK]
   answer(album(“Arrival”))
   add album(“Arrival”) to RESTR; remove incompatible restrictions from
   CTXT
   RESTR={artist(ABBA) album(Arrival)}
   CTXT.album={album (“Arrival”)}
   CTXT.id={{id(a4775), title(“Mamma Mia”), album(“Arrival”), artist(ABBA)}, {id(a4776), title(“Money Money Money”), album(“Arrival”), artist(ABBA)}}
S: “what song?” (shows “Mamma Mia” and “Money Money Money”).
U: “Mamma Mia”.
   Since the user answer points to one single item, the answer answer(id(a4775)) can be generated.

Utterances regarding the GUI (“down”, “up”, “mark”, “done”) are interpreted as dialogue moves which update POINTED-AT and MARKED. “done” causes a sequence of answer-moves are generated.

Manipulating the menu navigation device updates POINTED-AT and MARKED directly. Commands of the type “sort by year”, “sort by album” updates SORTING and SORT-INCREASING.

### Interrupter

A dialogue system may based on the kind of system described in Larsson 2002, where the dialogue logic consists of a data collection (an information state) and a collection of information state update rules (Information State Update approach, as described in Larsson & Traum). The data collection contains, among other relevant dialogue context, a model of each electronic device which is controlled by the dialogue system. There can be one or more devices controlled by the system. There can also be one or more models of devices not controlled by the system, but whose internal states are still relevant to the dialogue system included in the Information State.

When the state of a device is changed—for instance when a telephone call is coming in—the telephone is responsible for notifying the system about the change of state. Other relevant changes of state include (but is not limited to) situations:
When a navigation device indicates that it is approaching a junction where the driver is supposed to turn.
When a device in a vehicle is indicating that the driver is distracted.
When a device in a vehicle is indicating that the traffic situation requires the attention of the driver.
When a device in a vehicle, comprising among other features a button/key, which the user can use to indicate when she or he wants to initiate or cancel a dialogue with the system, indicates that the user wants to initiate or cancel a dialogue with the system.

In the IBDM (Issue Based Dialogue Management) manager, there is a collection of rules, the Select module, responsible for selecting the next system move. The select module should take into account the states of the devices modeled in the total information state. Taking the states into account means different things in different situations. In a dialogue with a music player, when the phone device description indicates an incoming phone call, the selection rules should select a “dialogue move” which indicates that the dialogue is being interrupted because of the incoming call. Alternatively, the incoming call could activate a plan designed to inform the user that there is an incoming phone call, and then ask the user whether he or she wants to answer the call. After the call is finished, the system can reintroduce the previous topic.

Such a dialogue could look like in the following example:
S>Which contact would you like to call?
U>John
S>There is an incoming phone call from Eric. Do you want to answer it?
U>Yes.
S>OK. Answering phone.
. . .
S>Returning to the issue of calling. John. Do you want to call his mobile number or his home number?
U> . . .

It may not always be practical to have a multi modal dialogue system activated. It is almost inevitable that a dialogue system equipped with a large coverage ASR unit recognizes utterances as directed to it, even when utterances are not directed to it. The utterance may also consist of noise that is not a real utterance, or of words which isn't really covered by the ASR recognition grammar. Also, a driver may be under high cognitive load so that he or she does not want to continue the interaction at the moment, but prefers to return to the issue at a later point in time.

A standard way to handle this is to provide a “push-to-talk” or “hold-to-talk” button, which means that a button must be pushed (and held) for the system to register spoken input. Another solution is to use a “push-to-initiate” button, which must be pushed for the system to start registering input. A third option is to use a button, a keyword or some kind of event generated from an electronic device as a pause event.

The later approach seems very fruitful, with the exception that the invention claimed doesn't match the IBDM/ISU architecture. The mentioned invention is centered around commands, requests and signals, while the IBDM model is centered around the concepts of context modeling, reasoning, inference rules and decision making.

The following is designed to be used in the flexible dialogue framework, but is also useful in any dialogue context.

An IBDM system can be equipped with the possibility to be in either “active mode” or “passive mode”. A system in active mode is in a conversation. It is asking and answering questions and is trying to drive the dialogue forwards. A system in active mode, which has asked the user a question a specified number of times without receiving an answer, enters passive mode. A system in passive mode doesn't react to verbal user actions, and doesn't ask questions. However, the graphical/haptic part of the system is still available for interaction.

To enable the user to control the transition from passive to active mode, and also the other way around, a combined button and display is used. When the system is started, it is in passive mode. When pushing the button in passive mode, the system enters active mode. When pushing the button in active mode, the system enters passive mode.

The display part of the device displays the mode of the system, for instance by having a certain color in active mode and another one in passive mode, or by being lit up in one mode and not the other, by showing a certain image in one mode and another image in the other, etc.

The button/display device may be modeled in the information state, and the transitions between the modes can be modeled by using standard ISU rules with preconditions and effects, reacting to certain configurations of the information state, effecting certain parts of the information state.

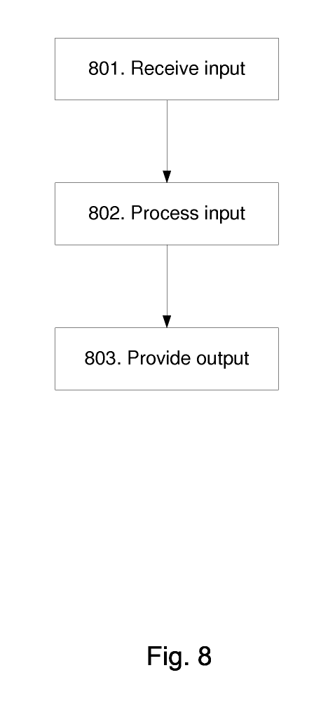

The present solution will now be described by referring to FIG. 8 which is a flowchart describing the present for handling a menu-based user interface. The method comprises the steps to be performed:

### Step 801

Input is received through the user interface. The input is at least one of audio input and menu navigation device input.

### Step 802

The input is processed using Basic Dialogue, “BD” and Speech Cursor, “SC”.

The input may be further processed by using Flexible Dialogue, “FD”. Flexible Dialogue may comprise at least one of grounding, accommodation, multiple topics, and meta-dialogue. Grounding may comprise at least one of basic grounding, multi-modal grounding, multi-choice grounding.

The input may be further processed by using Multimodal Parallelism, “MP”.

The input may be further processed by using Flexible Dialogue, “FD” and Multimodal Parallelism, “MP”.

### Step 803

Output is provided through the user interface. The output is at least one of audio output, and audio and visual output.

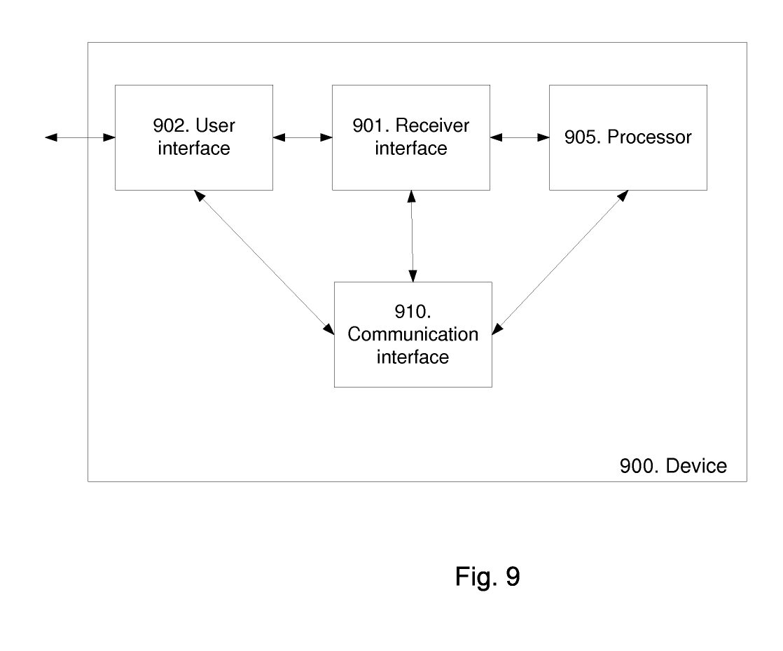

To perform the method steps shown in FIG. 8 for handling a menu-based user interface a device 900 as shown in FIG. 9 is provided. The device 900 comprises a receiver interface 901 which is arranged to receive input through the user interface 902. The input being at least one of audio input and menu navigation device input. The device 900 also comprises a processor 905 arranged to process the input using Basic Dialogue, “BD” and Speech Cursor, “SC” and a communication interface 910 arranged to provide output through the user interface 902. The output being at least one of audio output, and audio and visual output. The processor may further be arranged to process the input using Flexible Dialogue, “FD”, and to process the input using Multimodal Parallelism, “MP”. The processor may even further be arranged to process the input using Flexible Dialogue, “FD” and Multimodal Parallelism, “MP”. Flexible Dialogue may comprise at least one of grounding, accommodation, multiple topics, and meta-dialogue. Grounding may comprise at least one of basic grounding, multi-modal grounding, multi-choice grounding.

The user interface 902 may comprise a microphone and a speaker (not shown). It may also comprise a screen and a menu navigation device. The processor 905 may comprises an automatic speech recognising unit (ASR), a text-to-speech unit (TTS), an interpretation module (potentially integrated with other functionality), an optional generation module (potentially integrated with other functionality) and a dialogue manager, which when any uncertainty arises whether the system has recognised the user utterance correctly processes the user utterance in accordance with the process described above to present a list to chose from and where the user can select an item by using a audio input.

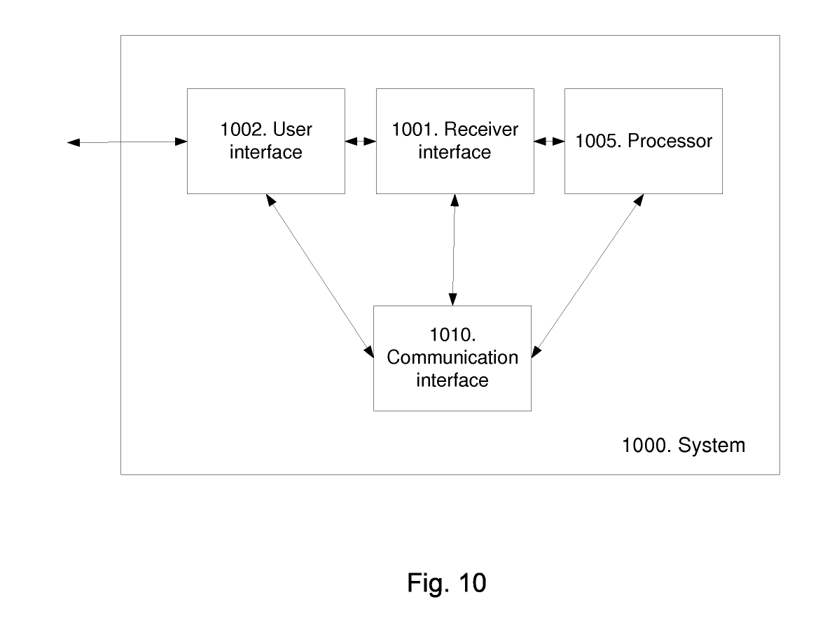

To perform the method steps in FIG. 8 for handling a menu-based user interface, a system 1000 as shown in FIG. 10 may be provided. The system comprises a receiver interface unit 1001 arranged to receive input through the user interface 1002. The input is at least one of audio input and menu navigation device input. The system 1000 further comprises a processing unit 1005 arranged to process the input using Basic Dialogue, “BD” and Speech Cursor, “SC”, and a communication interface unit 1010 arranged to provide output through the user interface 1002. The output is at least one of audio output, and audio and visual output. The processing unit 1005 may further be arranged to process the input using Flexible Dialogue, “FD”. The processing unit 1005 may further be arranged to process the input using Multimodal Parallelism, “MP”, and to process the input using Flexible Dialogue, “FD” and Multimodal Parallelism, “MP”. Flexible Dialogue may comprise at least one of grounding, accommodation, multiple topics, and meta-dialogue. Grounding may comprise at least one of basic grounding, multi-modal grounding, multi-choice grounding.

Event though the examples above illustrates use of the present solution in relation to playing music and telephone numbers, the solution can off course also be utilized in other type of applications, such as for example tracking of packages, weather forecasts, settings of a photocopier etc. Also, a car can comprise the system 1000.

It should be noted that the word “comprising” does not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means”, “devices”, and “units” may be represented by the same item of hardware.

The present invention is not limited to the above described preferred embodiments. Various alternatives, modifications and equivalents may be used. Therefore, the above embodiments should not be taken as limiting the scope of the invention, which is defined by the appending claims. Other solutions, uses, objectives, and functions within the scope of the invention as claimed in the below described patent claims should be apparent for the person skilled in the art.

It should also be emphasized that the steps of the methods defined in the appended claims may, without departing from the present invention, be performed in another order than the order in which they appear in the claims.

### REFERENCES

[1] Stina Ericsson (editor), Gabriel Amores, Björn Bringert, Håkan Burden, Ann-Charlotte Forslund, David Hjelm, Rebecca Jonson, Staffan Larsson, Peter Ljunglöf, Pilar Manchon, David Milward, Guillermo Perez, and Mikael Sandin. Software illustrating a unified approach to multimodality and multilinguality in the in-home domain. Deliverable D1.6, Talk project, January 2007.
[2] David Hjelm, Ann-Charlotte Forslund, Staffan Larsson, and Andreas Wallentin. DJ GoDiS: Multimodal Menu-based Dialogue in an Asynchronous Information State Update System. In Gardent and Gaiffe, editors, Proceedings of the ninth workshop on the semantics and pragmatics of dialogue, 2005.
[3] Staffan Larsson. Issue-Based Dialogue Management. PhD thesis, University of Gothenburg, 2002.

1-19. (canceled)

20. A method for handling a menu-based user interface, the menu-based interface comprising at least a menu and at least a menu item;
the method comprises the steps of:
receiving input through the menu-based interface, which input is at least one of:
a haptic menu navigation device input associated with a menu navigation action, the menu navigation action being associated with the menu and the menu item, and
an audio input comprising either
the menu navigation action associated with the menu and the menu item, or
a domain-level utterance input comprising one or several of the following domain-level utterance input types: requesting information, providing information, requesting actions, and confirming a status of a requested action;
processing the input using Basic Dialogue, “BD” and Speech Cursor, “SC”, where SC comprises a mechanism associating haptic input with audio output, and BD comprises mechanisms associating the domain level utterance input with a domain level utterance output comprising one or several of the following domain-level utterance types: requesting information, providing information, requesting actions, and confirming the status of the requested action, handling an interaction where a user and the menu-based user interface take turns to produce domain-level utterance output;
providing output, wherein the output is at least one of a visual output through the menu navigation device and an audio output, wherein SC provides the audio output in the form of a spoken representation of the menu item in focus whenever the menu item gets into focus as a result of the menu navigation action, and wherein BD provides the domain level utterance output.

21. The method according to claim 20,
wherein the step of processing the input further uses Flexible Dialogue, “FD”, where FD is an addition to basic dialogue, and wherein FD comprises at least one of:
verifying a validity of an menu-based interface's interpretation of the input, referred to as grounding;
processing the input, which input comprises information in addition to, or different from, information requested by the menu-based interface;
processing the input associated with another menu than the menu currently being processed; and
processing the input comprising a request for menu location information; and
wherein the output is menu location information.

22. The method according to claim 20,
wherein the step of processing the input further uses Multimodal Parallelism, “MP”, where MP comprises a correspondence between audio domain level utterance and the menu navigation action.

23. The method according to claim 20,
wherein the step of processing the input further uses Flexible Dialogue, “FD” and Multimodal Parallelism, “MP”.

24. The method according to claim 21,
wherein the grounding comprises at least one of basic grounding, multi-modal grounding, multi-choice grounding, wherein an input response is a response to the output, and where multi-modal grounding comprises
verifying the validity of the menu-based interface's interpretation of the input, where the output is at least one of audio output and visual output, which output is associated with an interpretation of the input, which input response is associated with a correct or incorrect interpretation of the input, and which input response is at least one of audio input and menu navigation device input, and
where multi-choice grounding comprises
verifying the validity of the menu-based interface's interpretation of the input, where the output is associated with a list of interpretations of the input, which input response is associated with a correct interpretation of the input, and which input response is at least one of audio input and menu navigation device input.

25. A device for handling a menu-based user interface, the menu-based interface comprising at least a menu and at least a menu item;
the device comprising:
a receiver interface arranged to receive input through the user interface, which input is at least one of:
a haptic menu navigation device input associated with a menu navigation action, the menu navigation action being associated with the menu and the menu item, and
an audio input comprising either
the menu navigation action associated with the menu and the menu item, or
a domain-level utterance input comprising one or several of the following domain-level utterance input types: requesting information, providing information, requesting actions, and confirming a status of a requested action;
a processor arranged to process the input using Basic Dialogue, “BD” and Speech Cursor, “SC”, where SC comprises a mechanism associating haptic input with audio output, and BD comprises mechanisms associating the domain level utterance input with a domain level utterance output comprising one or several of the following domain-level utterance types: requesting information, providing information, requesting actions, and confirming the status of the requested action, handling an interaction where a user and the menu-based user interface take turns to produce domain-level utterance output,
a communication interface arranged to provide output, wherein the output is at least one of a visual output through the menu navigation device and an audio output, wherein SC provides the audio output in the form of a spoken representation of the menu item in focus whenever the menu item gets into focus as a result of the menu navigation action, and wherein BD provides the domain level utterance output.

26. The device according to claim 25,
wherein the processor is further arranged to process the input using Flexible Dialogue, “FD”, where FD is an addition to basic dialogue, and wherein FD comprises at least one of:
verifying a validity of an menu-based interface's interpretation of the input, referred to as grounding;
processing the input, which input comprises information in addition to, or different from, information requested by the menu-based interface;
processing the input associated with another menu than the menu currently being processed; and
processing the input comprising a request for menu location information; and
wherein the output is menu location information.

27. The device according to claim 25,
wherein the processor is further arranged to process the input using Multimodal Parallelism, “MP”, where MP comprises a correspondence between audio domain level utterance and the menu navigation action.

28. The device according to claim 25,
wherein the processor is further arranged to process the input using Flexible Dialogue, “FD” and Multimodal Parallelism, “MP”.

29. The device according to claim 26,
wherein grounding comprises at least one of basic grounding, multi-modal grounding, multi-choice grounding, wherein an input response is a response to the output, and where multi-modal grounding comprises
verifying the validity of the menu-based interface's interpretation of the input, where the output is at least one of audio output and visual output, which output is associated with an interpretation of the input, which input response is associated with a correct or incorrect interpretation of the input, and which input response is at least one of audio input and menu navigation device input, and
where multi-choice grounding comprises
verifying the validity of the menu-based interface's interpretation of the input, where the output is associated with a list of interpretations of the input, which input response is associated with a correct interpretation of the input, and which input response is at least one of audio input and menu navigation device input.

30. A car comprising a device according to claim 25.
